(19) United States
(12) Patent Application Publication
(10) Pub. No.: US 2017/0195688 A1
(43) Pub. Date: Jul. 6, 2017

(54) Methods and Devices for Intra Coding of Video

(71) Applicant: Telefonaktiebolaget LM Ericsson (publ), Stockholm (SE)

(72) Inventors: Rickard Sjöberg, Stockholm (SE); Jonatan Samuelsson, Stockholm (SE); Per Wennersten, Årsta (SE)

(21) Appl. No.: 15/403,957

(22) Filed: Jan. 11, 2017

Related U.S. Application Data
(63) Continuation of application No. 13/978,918, filed on Jul. 10, 2013.
(60) Provisional application No. 61/432,675, filed on Jan. 14, 2011.

(51) Int. Cl. H04N 19/59; H04N 19/159

(52) U.S. Cl. CPC H04N 19/59; H04N 19/159; H04N 19/176

(57) ABSTRACT

Encoder, decoder and methods for intra coding of video. The method in the decoder relates to decoding of an intra coded block IZ having a number N of neighboring blocks CU₁-CU_{N}. When at least one block CUₖ of the number of neighboring blocks is unavailable for intra prediction, pixel values for spatial positions covered by CUₖ are estimated based on at east one pixel value of at least one of blocks CUₖ₋ₘ and CUₖ₊ₚ within the range [CU₁-CUₖ₋₁, CUₖ₊₁-CU_{N}]of blocks, which is available for intra prediction. Further, the block IZ is decoded, using the estimated pixel values for prediction, thus generating a block Z of pixels. k, m and p are integers, and 1≦k≦N; 1≦m<k; and 1≦p≦N−k; and N is a positive integer.

### RELATED APPLICATIONS

This application is a continuation under 35 U.S.C. §120 of co-pending U.S. patent application Ser. No. 13/978,918, filed Jul. 10, 2013, which is a national stage entry under 35 U.S.C. §371 of international patent application Ser. No. PCT/SE2012/050017, filed Jan. 12, 2012, which claims priority to and the benefit of U.S. provisional patent application Ser. No. 61/432,675, filed Jan. 14, 2011. The entire contents of each of the aforementioned applications is incorporated herein by reference.

### TECHNICAL FIELD

The invention relates to video coding, particularly to so-called intra-coding of parts of video frames.

### BACKGROUND

Digital video signals, in non-compressed form, typically contain large amounts of data. However, the actual necessary information content is considerably smaller due to high temporal and spatial correlations. Accordingly, video compression or coding is used to reduce the amount of data which is actually required for certain tasks, such as storage or transmission of the video signals. In the coding process temporal redundancy can be used by making so-called motion-compensated predictions, where regions of a video frame are predicted from similar regions of the previous frame. More specifically, there may be parts of a frame that do not contain any, or only slight, change from corresponding parts of the previous frame. Alternatively, if a good match with a previous frame cannot be found, predictions within a frame can be used to reduce spatial redundancy. With a successful prediction scheme, the prediction error will be small and the amount of information that has to be coded will be greatly reduced. Moreover, by transforming pixels to a frequency domain, e.g., by using a Discrete Cosine Transform (DCT), spatial correlations provide further gains and efficiency.

Notwithstanding the benefits of video data compression, the coded bit stream i.e., compressed data which is transmitted from one location to another, may become corrupted due to error-prone transmission channels. If this happens, relying too much on prediction may cause large potential damage, as prediction may propagate errors and severely decrease video quality. Accordingly, a technique has been developed in the prior art to reduce such damage by preventimg temporal predictions at certain times, and more particularly by forcing a refresh (i.e., coding with no reference to previous frames) of a region or an entire picture. By distributing the refresh of different regions over many frames, the coding penalty can be spread out evenly. Then, in the event of an error, the video sequence can be recovered successfully frame-by-frame as the damage is corrected.

Herein, the terms “picture” and “frame” are used interchangeably to refer to a frame of image data in a video sequence.

It is seen from the above statements that the overall quality of a decoded video signal (following compression and transmission) is a trade-off between high compression on the one hand, and error resilience on the other. It is desirable to achieve high compression by employing prediction, particularly in error-free transmissions. However, it is also necessary to be able to limit error propagation caused by error-prone transmission channels.

Common video coding standards, such as the ITU-T Recommendations H.261 and H.263 and the ISO/IEC standards MPEG-1, MPEG-2 and MPEG-4, divide each frame of a video signal into 16×16 pixel regions called macroblocks. These blocks are scanned and coded sequentially row by row, from left to right.

H.264 (MPEG-4 AVC) is the state of the art video coding standard. It is a hybrid codec which takes advantages of eliminating redundancy between frames and within one frame. The output of the encoding process is VCL (Video Coding Layer) data which is further encapsulated into NAL (Network Abstraction Layer) units prior to transmission or storage.

High Efficiency Video Coding (HEVC) is a new video coding standard currently being developed in Joint Collaborative Team-Video Coding (JCT-VC). JCT-VC is a collaborative project between MPEG and ITU-T. Currently, an HEVC Model (HM) is defined that includes large macroblocks (hierarchical block coding) and a number of other new tools and is considerably more efficient than H.264/AVC.

As video resolutions have increased, it has been noticed that large macroblocks can provide good video coding benefits. Traditionally, macroblocks are in the order of 16×16 pixels (e.g. H.264), but has been shown that macroblocks of up to 128×128 pixels can provide inproved coding efficiency.

To enable both large macroblocks, and the coding of small detailed areas in the same image, hierarchical coding is used. This is the case for the HM in JCT-VC.

Large macroblocks (referred to as Largest Coding Units (LCU) in the HM) are scanned left to right in the same way as normal macroblocks. Each large macroblock may be split, and the resulting blocks may be split again hierarchically in a quad-tree fashion. The blocks are called Coding Units (CU). There is also a smallest size defined, these blocks are called Smallest Coding Unit (SCU).

FIG. 1 shows an example block structure, with large macroblocks on the left (scanned left to right), and an example hierarchical split structure of a macroblock on the right. FIG. 2 shows an example scan order inside a large macroblock which has been split into smaller CUs.

Each picture is divided into one or more slices. Each slice is an independently decodable piece of an image. In other words, if one slice is lost, the other slices of that frame are still decodable. In H.264/AVC, a slice boundary may occur between any two macroblocks.

In the HEVC Model (HM), a slice boundary may occur between any two LCU. Document JCTVC-C154 proposes slice boundaries to be allowed at any CU

Intra coding is performed relative to information that is contained only within the current picture or frame, and not relative to any other frame in a video sequence. In other words, no temporal estimating uniting is performed, since temporal estimating uniting extends outside of the current picture or frame. Intra coding involves intra prediction. Below, intra prediction as currently performed in a number of different standards will be described.

The current HEVC CU Intra Prediction consists of a selected direction that specifies the direction from where pixel values are predicted. One example is the vertical prediction direction, where neighboring top pixel values are copied into the current CU to form the Intra prediction. FIG. 3 shows the 33 prediction directions used in the HEVC draft. There is also a DC prediction.

When coding a block according to HEVC, the use of five neighboring macroblocks is defined. The five neighboring macroblocks used for coding in HEVC are:
Above
Left
AboveLeft
TopRight
BelowLeft

The HM coder uses the pixel value equal to 1<<(bit_depth-1) for pixels in unavailable macroblocks. If Above is available but TopRight is not, the rightmost pixel value in Above is copied to all TopRight prediction positions. Similarly, if Left is available but BelowLeft is not, the lowest positioned pixel value in Left is copied to all BelowLeft prediction positions.

One or more of these neighboring macroblocks may be missing due to the location of the block to be encoded in relation to the frame border. If Above is available but TopRight is missing, the rightmost pixel value in Above is copied to all TopRight prediction positions.

### 4×4 Luma Intra Prediction in H.264

4×4 luma. Intra prediction in H.264 consists of the directions shown in FIG. 4. There are 8 directional modes and the DC prediction mode (which is mode number 2, not shown in FIG. 4):
Mode 0 (vertical prediction) is not allowed if the macroblock to the left is unavailable.
Mode 1 (horizontal prediction) is not allowed if the macroblock above is unavailable.
Mode 2 (DC prediction) is always available. Pixels A-D and I-L are averaged to form a DC value. If A-D or I-L are unavailable, the four available pixels are averaged. If all are unavailable, the pixel value in the middle of the pixel range is used as DC, e.g. 128 for 8-bit video.
Mode 3 (down-left prediction) and Mode 7 are not allowed if the macroblock above is unavailable. If pixels E-H are unavailable, pixel value D will be used for these positions (extrapolation)
Mode 4 (diagonal down-right) is only if macroblocks above, above-left and left are all available.
Mode 5 and Mode 6 have the same constraint as Mode 4.
Mode 8 is only available if the macroblock to the left is available. It does not use pixels M-P for prediction.

### 16×16 Luma Intra Prediction in H.264

16×16 luma Intra prediction in H.264 consists of 4 modes:
Mode 0 (vertical prediction), Mode 1 (horizontal prediction) and Mode 2 (DC prediction) works similar to the 4×4 luma Intra prediction with the same constraints.
Mode 3 (planar prediction) is only allowed if macroblocks above, above-left and left are all available.

### 8×8 Luma Intra Prediction in H.264

8×8 luma Intra prediction in H.264 is done similar to the 4×4 luma Intra prediction, with the difference that 8×8 blocks are used instead and that low-pass filtering of the predictor done to improve the compression efficiency. Extrapolation of pixels for the top-right neighboring block is done similarly to Mode 3 and Mode 7 for 4×4 luma Intra prediction.

### H.264 Chroma Prediction

The H.264 chroma prediction is similar to the 16×16 luma Intra prediction. It consists of the same four modes and does not extrapolate any pixel values in its calculations.

With HEVC, the op and/or left border of a current CU may be formed by a higher number of CUs than before, which CUs may represent a mix of CUs that are available for Intra prediction and CUs that are not available for Intra prediction. It is a challenge to improve the Intra coding efficiency in such a HEVC scenario.

### SUMMARY

It would be desirable to improve the efficiency of intra coding of video, and further to do so also for coding techniques applying hierarchical coding. It is an object of the invention to improve the efficiency of intra coding of video, especially for coding techniques applying hierarchical coding.

Briefly described, the invention relates to a solution for handling of neighboring CUs which are unavailable for intra prediction of a current CU. The solution is mainly intended to solve the problem in HEVC, where CUs may be of different sizes and slice borders may be configured between any two CUs. However, the solution is also applicable in situations where the neighboring CUs are of equal size as a current CU.

The solution described herein involves a method of interpolating or extrapolating pixel values to provide the Intra prediction function in a video encoder and decoder with pixel values better than default values, i.e. pixel values which enable a higher compression efficiency than the use of default values.

According to a first aspect, a method is provided for decoding an intra coded block IZ having a number N of neighboring blocks CU₁-CU_{N}. When at least one block, CUₖ, of the number of neighboring blocks is unavailable for intra prediction, pixel values are estimated for spatial positions covered by CUₖ, based on at least one pixel value of at least one of blocks CUₖ₋ₘ and CUₖ₊ₚ within the range [CU₁-CUₖ₋₁, CUₖ₊₁-CU_{N}] of blocks, which is available for intra prediction. Further, the block IZ is decoded using the estimated pixel values for prediction, thus generating a block Z of pixels.

According to a second aspect, a decoder is provided for decoding an intra coded block IZ having a number N of neighboring blocks CU₁-CU_{N}. The decoder comprises a determining unit, adapted to determine whether a block CUₖ of the number of neighboring blocks is unavailable for intra prediction. The decoder further comprises an estimating unit, adapted to, when a block CUₖ is determined to be unavailable for intra prediction, estimate pixel values for spatial positions covered by CUₖ, based on at least one pixel value of at least one of blocks CUₖ₋ₘ and CUₖ₊ₚ within the range [CU₁-CUₖ₋₁, CUₖ₊₁-CU_{N}] of blocks, which at least one block is available for intra prediction. The decoder further comprises a decoding unit, adapted to decode block IZ, using the estimated pixel values for prediction, thus generating a block Z of pixels.

According to a third aspect, a method is provided for encoding a block Z of pixels, the block Z having a number N of neighboring blocks CU₁-CU_{N}. When at least one block, CUₖ, of the number of neighboring blocks is unavailable for intra prediction, pixel values are estimated for spatial positions covered by CUₖ, based on at least one pixel value of at least one of blocks CUₖ₋ₘ and CUₖ₊ₚ within the range [CU₁-CUₖ₋₁, CUₖ₊₁-CU_{N}] of blocks, which is available for intra prediction. Further, the block Z is encoded using the estimated pixel values for prediction, thus generating an intra-coded block IZ.

According to a fourth aspect, an encoder is provided for encoding a block Z of pixels, the block Z having a number N of neighboring blocks [CU₁-CU_{N}]. The encoder comprises a determining unit, adapted to determine whether a block CUₖ of the number of neighboring blocks is unavailable for intra prediction. The encoder further comprises an estimating unit, adapted to estimate, when a block CUₖ is determined to be unavailable for intra prediction, pixel values for spatial positions covered by CUₖ, based on at least one pixel value of at least one of blocks CUₖ₋ₘand CUₖ₊ₚ within the range [CU₁-CUₖ₋₁, CUₖ₊₁-CU_{N}] of blocks, which at least one block is available for intra prediction. The encoder further comprises an encoding unit, adapted to encode the block Z, using the estimated pixel values for prediction, thus generating an intra-coded block IZ.

For all aspects above, k, m and p are integers, and 1≦k≦N; 1≦m<k; and 1≦p≦N-k; and N is a positive integer.

The above methods and devices may be used for enabling an improvement of coding/compression efficiency of Intra prediction e.g. for constrained Intra and/or when small granularity slices and hierarchical coding is used. By use of the above methods and devices, the amount of allowed Intra prediction directions may be maximized.

The above methods and devices may be implemented in different embodiments. For example, the blocks CUₖ₋ₘ and CUₖ₊ₚ, are the closest blocks to CUₖ in a respective direction within the range [CU₁-CUₖ₋₁, CUₖ₊₁-CU_{N}] of blocks, which are available for intra prediction. Further, the estimation of pixel values may involve interpolation between pixel values of two blocks or extrapolation from one block. The reason for that the block CUₖ is unavailable may be that it belongs to a different slice than the block IZ/Z. Alternatively, the block CUₖ may be unavailable due to that it is temporally predicted, and the encoding/decoding is to be performed in constrained intra mode, or, that CUₖ has not yet been decoded/encoded. The decoder and encoder may support hierarchical coding, i.e. support hierarchical coding and neighboring blocks of different sizes. This is expressed as that the decoder and encoder supports values of N>5.

The embodiments above have mainly been described in terms of a method. However, the description above is also intended to embrace embodiments of the decoder and encoder, configured to enable the performance of the above described features. The different features of the exemplary embodiments above may be combined in different ways according to need, requirements or preference.

### BRIEF DESCRIPTION OF THE DRAWINGS

The invention will now be described in more detail by means of exemplifying embodiments and with reference to the accompanying drawings, in which:

FIG. 1 shows an example block structure, with large macroblocks on the left, and an example hierarchical split structure on the right, according to the prior art.

FIG. 2 shows an example scan order inside a large macroblock, according to the prior art.

FIG. 3 shows the angular Intra prediction directions in HEVC, according to the prior art (source JCTVC-A119 and JCTVC-B100).

FIG. 4 shows the 9-mode angular Intra prediction in H.264, according to the prior art.

FIG. 5 shows an example of neighboring block partitions in HEVC, according to the prior art.

FIG. 6 shows an example of neighboring block types, where “I” represents Intra coded blocks, and “P” represents non-Intra coded blocks, according to the prior art.

FIG. 7 shows an example 1D sequence of surrounding/neighboring blocks of a current block.

FIG. 8 illustrates pixel positions for which pixel values are to be estimated (1-4), and pixels (A-E) on which the estimates may be based.

FIG. 9 shows a scenario where some neighboring blocks of a current block are unavailable for Intra prediction due to the location of a slice border.

FIGS. 10a-b are flow charts illustrating procedures, according to exemplifying embodiments.

FIG. 11 is a block diagram illustrating an encoder according to an exemplifying embodiment.

FIG. 12 is a block diagram illustrating a mobile terminal comprising an encoder according to an exemplifying embodiment.

FIGS. 13a-b are flow charts illustrating procedures, according to exemplifying embodiments.

FIGS. 14 is a block diagram illustrating a decoder according to an exemplifying embodiment.

FIG. 15 is a block diagram illustrating a mobile terminal comprising a decoder according to an exemplifying embodiment.

FIG. 16 is a block diagram illustrating a computer program product according to an exemplifying embodiment.

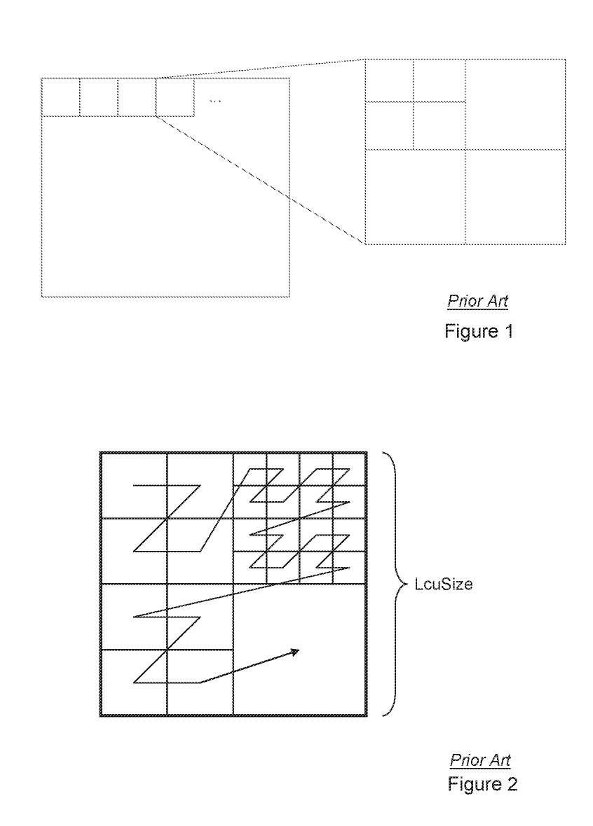

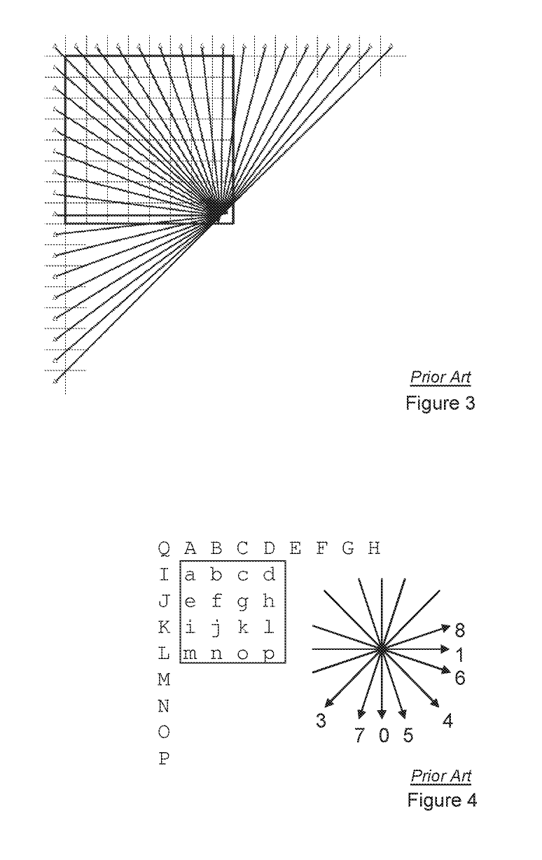

### DETAILED DESCRIPTION

A neighboring block can be unavailable for prediction for a number of reasons. Some examples of reasons are:
The block is not yet decoded (or encoded);
The block belongs to a different slice;
The block is not intra coded (but instead inter coded, using temporal prediction) and the mode “constrained intra” is activated, in which mode only intra coded blocks may be used for prediction;
The block is outside the picture/frame

Most of the following examples assume the third case above, i.e. that the neighboring block is not intra coded and that a constrained intra mode is activated. However, the method can be applied for any reason of a block being unavailable for prediction.

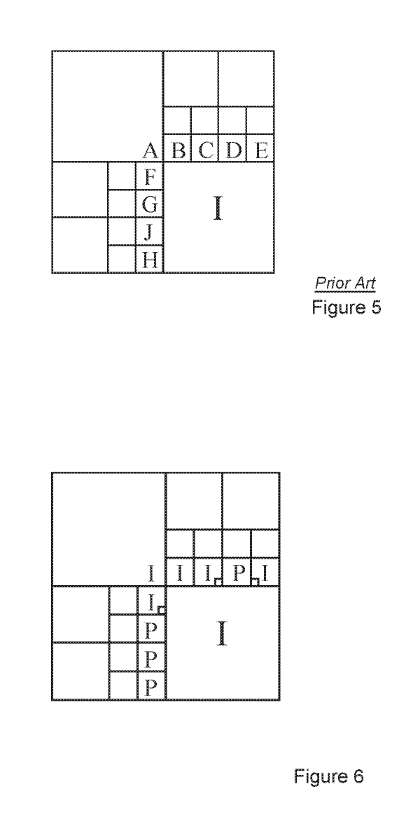

FIG. 5 shows a set of CUs or blocks of different sizes. Block “I” is a block which is to be decoded, and is also denoted “the current block”. Along the left and top border of the current block “I”, there are a number of neighboring blocks, A-H, which are assumed to already have been decoded. If assuming that all of the blocks A-I belong to the same slice of a frame, and further assuming that the mode “constrained intra” is turned on, it depends on the coding type of the blocks A-H whether they are available for prediction or not. By coding type is here meant Intra coded or non-Intra coded.

FIG. 6 illustrates an example of how the neighboring blocks A-H in FIG. 5 could have been coded, and thus belong to different block types. Among the top neighboring blocks in FIG. 6 there is one temporally predicted, i.e. non-Intra coded, block (denoted P) among the Intra coded blocks (denoted I). In one exemplifying embodiment of the solution described herein, the unavailable or prohibited pixel values in the top non-Intra coded neighboring P block are assigned available and allowed pixel values by interpolation from the closest neighboring Intra coded pixel values. For example, either the average pixel values of the closest pixels or a linear interpolation can be used. In this case, the closest neighboring Intra coded pixel values are, when using the notation from FIG. 5, pixel values of the blocks C and E, which are located on each side of the P-block (denoted D in FIG. 5) along the top border of the block “I”.

Among the neighboring blocks to the left of the current block in FIG. 6 there are three temporally predicted (non-Intra coded) blocks. Here, extrapolation is used to fill in the unavailable pixel values. For example, the closest Intra coded pixel is simply repeated down to replace the unavailable pixel values.

It should be noted that the predictiveblocks do not necessarily need to be predicted from a single prediction picture, it can also be bi-predicted from two pictures.

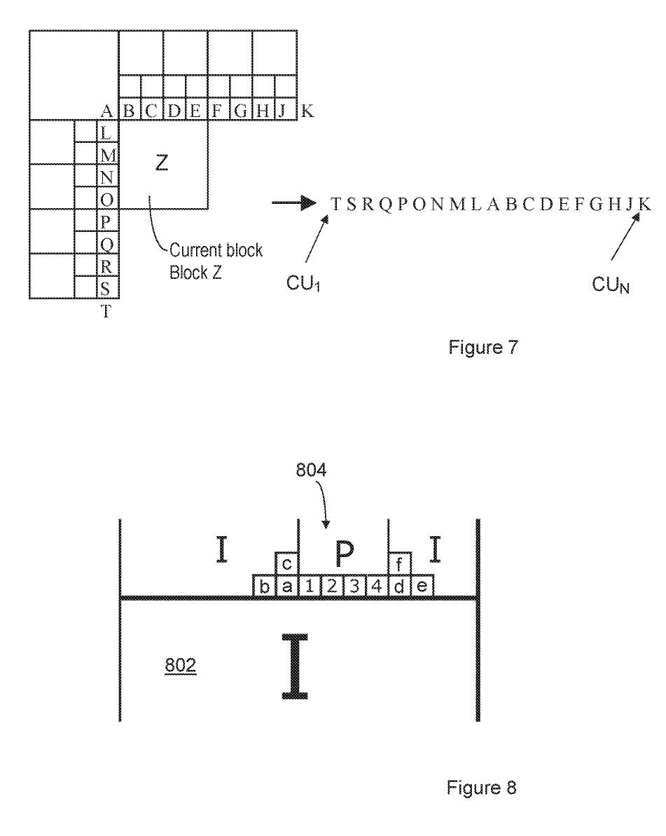

In a preferred embodiment, the surrounding or neighboring blocks, i.e. the blocks along the left and top border of a current block, and possibly the extension of said borders to the left and downwards, respectively, can be considered as being a 1D-sequence, as illustrated in FIG. 7.

In FIG. 7, the neighboring blocks are arranged or made into a 1D sequence of blocks, with the lowest left block, T, and rightmost top block, K, in a respective end. Here, the lower left block T has been regarded as the first block in the 1D sequence and been denoted CU₁ and the rightmost top block K has been regarded as the last block of the N blocks in the 1D sequence and been denoted CU_{N}. Further, the 1D sequence is described herein as having a “left to right” direction. However, alternatively, block K could be regarded as the first block and T as the last block, and/or the 1D sequence could be egarded e.g. as having a vertical top to bottom direction.

For non-Intra blocks in the 1D sequence, which are surrounded by Intra blocks, i.e. have at least one Intra block somewhere to the left and at least one Intra block somewhere to the right in the 1D sequence, the pixel values are replaced or filled in by interpolation based on the closest prediction-available pixel on both sides in the 1D sequence. For non-Intra blocks in the 1D sequence, which only have an available Intra coded block on one side, i.e. to the left or to the right, the pixel values are replaced by extrapolation from the closest pixel that is available for prediction. For example, if the rightmost and/or leftmost blocks are unavailable for prediction, extrapolation from the closest available pixel values would be used.

The number N of blocks in the 1D sequence, or “the border length”, could depend e.g. on the prediction size. For example, regarding the 1D sequence illustrated in FIG. 7, different sets of blocks could be considered as belonging to the 1D sequence. The 1D sequence could consist e.g. of the blocks S-J, i.e. blocks T and K could be outside the sequence. Alternatively, the 1D sequence in FIG. 7 could consist e.g. of blocks P-F (and not T-Q and G-K), or blocks O-E (and not T-P and F-K).

The interpolation between two or more pixel values can be done e.g. by computing the average of the closest pixels from each side or by using the closest pixels for linear interpolation. The extrapolation from one block can be done e.g. by simple pixel repetition. Another option is to use the average of the closest pixel and its closest neighboring pixel(s) from the same CU.

FIG. 8 illustrates a case where interpolation would be used. The large block 802 in the lower part of the figure is an intra block currently being decoded, which may also be denoted the current block. If constrained intra is being used, this means that the neighboring block 804, which is a temporally predicted (non-Intra) block, may not be used for Intra prediction. Thus, the pixel values in the pixels positions (or pixels) marked 1 through 4, which are part of or covered by block 804, may not be used for prediction (since they belong to a temporally predicted (non-Intra) block). Thus, new pixel values should be derived based on prediction-available pixel values, for the pixel positions marked 1-4. Simple interpolation can then be done for example by giving pixels in pixel position 1 through 4 the average value of pixels “a” and “d”, computed as e.g. (a+d)/2 or (a+d+1)>>1. Another method is to perform linear interpolation, e.g. the pixel in position 1 will be assigned the value 7/8*a+1/8*d, the pixel in position 2 will be assigned the value 5/8*a+3/8*d, the pixel in position 3 will be assigned 3/8*a+5/8*d and the pixel in position 4 will be assigned 1/8*a+7/8*d. This example can be described by the following notation: (1,3,5,7),8. Another option is to use (1,2,3,4),5 for interpolation. In the case of (1,3,5,7),8, the calculations can be done with shifts as e.g. (7*a+1*d+4)>>3. Additionally, rather than simply using a and d as basis for the interpolation, the averages (a+c)/2, (a+b)/2, (a+b+c)/3 or (2*a+b+c)/4 could be used instead. These averages could be calculated with shifts as (a+c+1)>>1, (a+b+1)>>1 and (2*a+b+c+2)>>2.

It is also possible to use other methods for interpolation and extrapolation such as e.g. higher order pot) approximation. In general, any interpolation and extrapolation method can be applied to retrieve pixel values to replace the unavailable prohibited pixel values.

In another embodiment, unavailable pixels values are not necessarily replaced by use of interpolation when there are available pixel values on both sides of the unavailable pixels in the 1D sequence. For example, it could be signaled to the decoder if interpolation, extrapolation from the left or extrapolation from the right should be used for replacement of the unavailable pixel values.

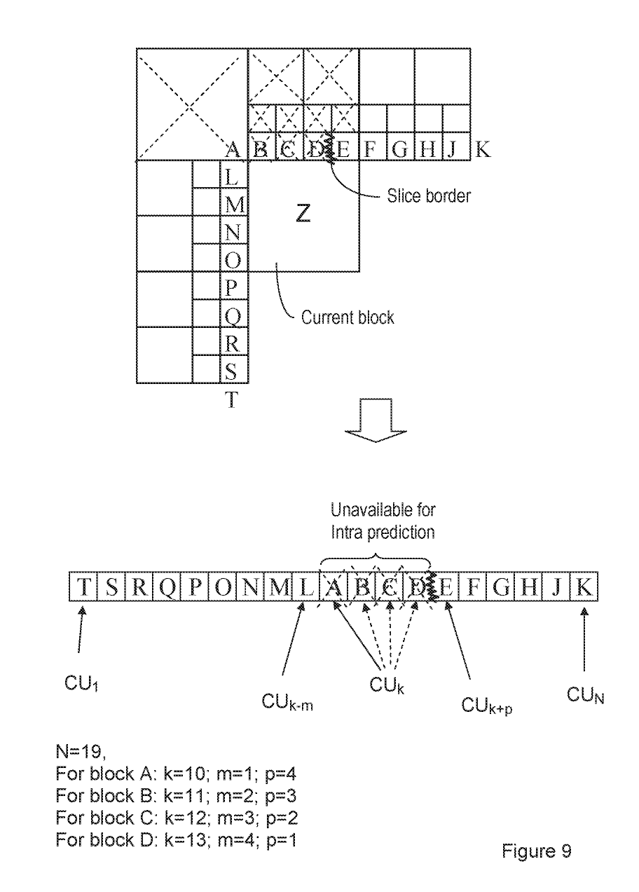

FIG. 9 shows an example where four neighboring blocks, A-D, to a current block are unavailable for Intra prediction due to that these blocks belong to another slice than the current block. This is illustrated as the zigzag slice border between block D and block E in FIG. 9. FIG. 9 also illustrates which blocks that may be used for deriving pixel values by interpolation, in order to replace unavailable pixel values of blocks A-D. In this example, blocks L and E may be used for such interpolation.

The ideas described here apply to both the decoding and encoding process of data/video.

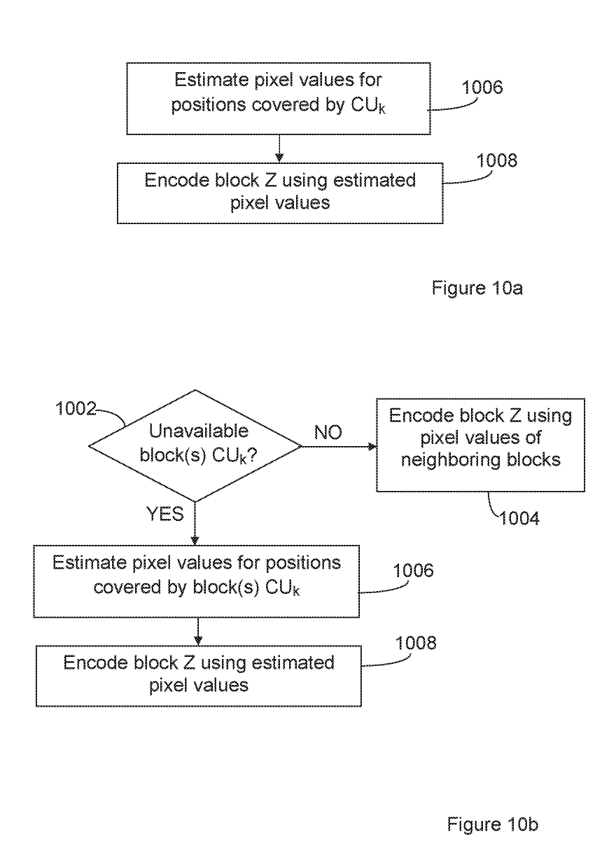

A generalized procedure for encoding a block, Z, of pixels will be described below with reference to FIG. 10a. The block Z is assumed to have a number N of neighboring blocks, CU₁-CU_{N}. When at least one block, CU_{K}, of the number of neighboring blocks is unavailable for Intra prediction, pixel values are estimated, in an action 1006, for spatial positions covered by the block CUₖ, (cf. e.g. position 1-4 in FIG. 8). The pixel values are estimated based on at least one pixel value of at least one of blocks CUₖ₋ₘ and CUₖ₊ₚ within the range [CU₁-CUₖ₋₁, CUₖ₊₁-CU_{N}] of blocks (cf. FIG. 9 for illustration of notation), which is available for intra prediction. Then, the block Z is encoded in an action 1008 using the estimated pixel values for prediction, and thus an intra coded block IZ of pixels is generated. The variables k, m and p are integers, and 1≦k≦N; 1≦m<k; and 1≦p≦N-k, where N is a positive integer. Example values of these variables are given in FIG. 9. In a preferred embodiment, the encoder supports values of N≦5 and values of N>5, such as is the case e.g. for HEVC. However, the solution is also applicable for cases where only values of N<5 are supported. It is considered to be an advantage f the solution described herein is that it generalizes to both types of encoders/codecs, and is applicable for all reasons for pixels being unavailable.

The pixel values may be estimated based on either pixel values of a block CUₖ₋ₘ to the left of the unavailable block CUₖ in a virtual 1D vector (cf. FIG. 9); or on pixel values of a. block CUₖ₊ₚ to the right of the unavailable block CUₖ in the virtual 1D vector, or, based on both of said blocks CUₖ₋ₘ and CUₖ₊ₚ. The reasons for that the block, CUₖ, is unavailable may be e.g. that CUₖ is temporally predicted, and the encoding is to be performed in constrained intra mode, or that CUₖ is not yet encoded.

The different embodiments and advantages of the encoding procedure correspond to the embodiments and advantages of the decoding procedure, and are described in further detail in conjunction with the decoding procedure further below.

In FIG. 10b, the action of determining whether one or more neighboring blocks are unavailable for intra prediction is illustrated as action 1002. If it is determined in action 1002 that one or more neighboring blocks are unavailable for Intra prediction, pixel values for positions covered by said unavailable block(s) are estimated in action 1006. If all neighboring blocks are determined to he available for Intra prediction, the current block is encoded using pixel values of the neighboring blocks, in an action 1004.

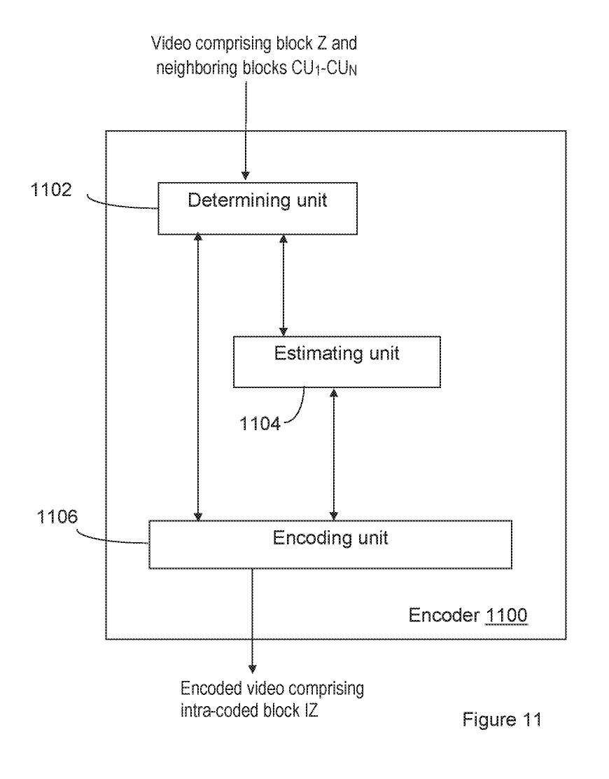

A generalized encoder for encoding a block, Z, of pixels will be described below with reference to FIG. 11. As described above, the block Z is assumed to have a number N of neighboring blocks, CU₁-CU_{N}. The block Z and the neighboring blocks are assumed to be provided to the encoder as input, e.g. as a part of a video stream from a camera. The encoder in FIG. 11 is illustrated as comprising a determining unit 1102, an estimating unit 1104, and an encoding unit 1106. These units or modules may represent processing circuitry, which is configured to perform the actions described above in conjunction with FIGS. 10a and 10b. The determining unit 1102 is adapted to determine whether a block CUₖ of the number of neighboring blocks is unavailable for intra prediction. The estimating unit 1104 is adapted to, when it is determined (by the determining unit 1102) that a block CUₖ is unavailable for Intra prediction, estimate pixel values for spatial positions covered by CUₖ (cf. position 1-4 in FIG. 8). The pixel values are estimated based on at least one pixel value of at least one of blocks CUₖ₋ₘ and CUₖ₊ₚ within the range [CU1-CUk−1, CUk+1-CUN] of blocks. The encoding unit 1106 is adapted to encode block Z using the estimated pixel values. Thus, by the encoding of the block Z, an intra coded block IZ is generated, which block may be provided e.g. to a decoder or a storage unit. As above: k, m and p are integers, and 1≦k≦N; 1≦m<k; and 1≦p≦N-k; and N is a positive integer.

The encoder or units described above may be implemented by e.g. one or more of: a processor or a micro processor and adequate software stored in a memory, a Programmable Logic Device (PLD), Field-Programmable Gate Array (FPGA), Application-Specific Integrated Circuit (ASIC) or other electronic component(s) configured to perform the actions mentioned above.

The encoder may be implemented in different embodiments corresponding to the embodiments of the procedure described above in conjunction with FIGS. 10a and 10b.

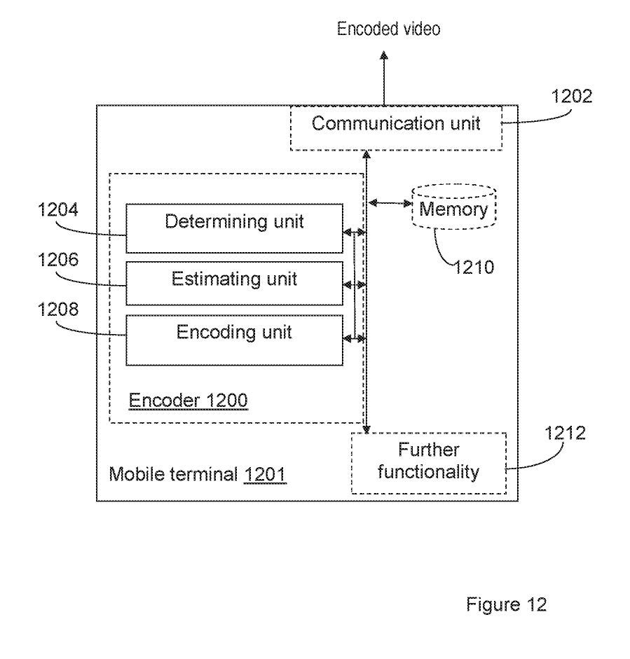

FIG. 12 illustrates a mobile terminal 1201, such as e.g, a User Equipment (UE) in a cellular communication network or a tablet, comprising an encoder 1200 as the one described above. The exemplifying mobile terminal in FIG. 12 further comprises a communication unit 1202 for communicating with other entities, such as e.g. radio base stations. The mobile terminal 1201 may further comprise one or more memories, e.g. for storing of encoded video, and further functionality 1212, such as a camera for capturing video and a display/screen for displaying video. The video provided to the encoder may be retrieved e.g. from a camera comprised in the mobile terminal or from another entity via the communication unit 1202, or from a memory 1210 within the mobile terminal. The mobile terminal may further comprise a decoder as the one described below.

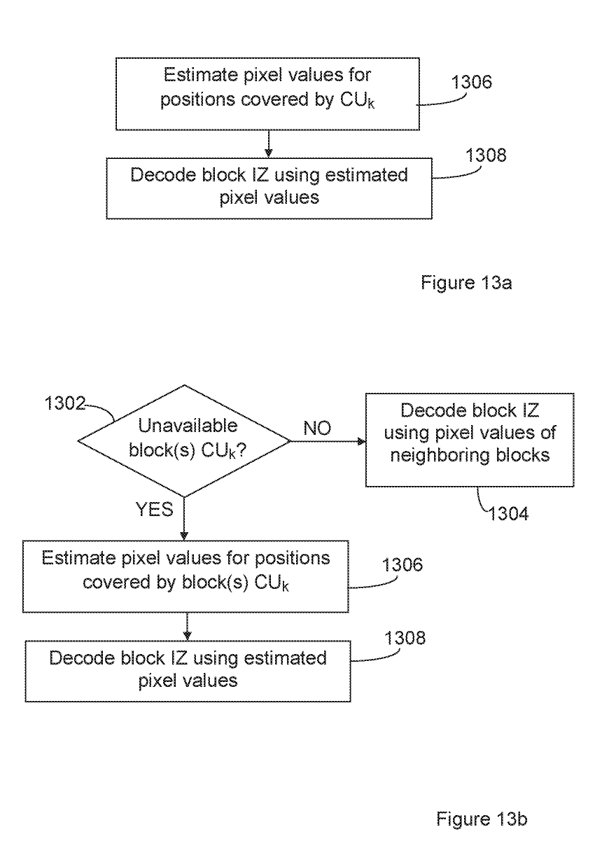

A generalized procedure for decoding an intra coded block, IZ, will be described below with reference to FIG. 13a. The Intra coded block is assumed to have a number N of neighboring blocks, CU₁-CU_{N}. When at least one block, CUₖ, of the number of neighboring blocks is unavailable for Intra prediction, pixel values are estimated, in an action 1306, for spatial positions covered by the block CUₖ (cf. e.g. position 1-4 in FIG. 8). The pixel values are estimated based on at least one pixel value of at least one of blocks CUₖ₋ₘ and CUₖ₊ₚ within the range [CU₁-CUₖ₋₁, CUₖ₊₁-CU_{N}] of blocks (cf. FIG. 9 for illustration of notation), which is available for intra prediction. Then, the Intra coded block IZ is decoded in an action 1308 using the estimated pixel values for prediction, and thus a block Z of pixels is generated. The variables k, m and p are integers, and 1≦k≦; 1≦m<k; and 1≦p≦N-k, where N is a positive integer. Example values of these variables are given in FIG. 9.

The pixel values may be estimated based on either pixel values of a block CUk-m to the left of the unavailable block CUₖ in a virtual 1D vector (cf. FIG. 9); or on pixel values of a block CUₖ₊ₚ to the right of the unavailable block CUₖ in the virtual 1D vector, or, based on both of said blocks CUₖ₋ₘ and CUₖ₊ₚ.

By estimating new pixel values, based on Intra prediction-available pixel values, for spatial positions where the original pixel values are unavailable for Intra coding/Intra prediction, these new values will be available for Intra prediction. By estimating the new pixel values based an neighboring/adjacent pixel values, which are available for Intra prediction, the estimates will be more adequate and relevant than if using e.g. default values. Thus, an increased coding efficiency is enabled.

The neighboring block(s) may be unavailable for Intra prediction for one or more of different reasons. For example, a neighboring block could be unavailable due to that it belongs to another slice of a picture than a current block (cf. FIG. 9). Further, a neighboring block could be unavailable due to that it is not yet decoded; or temporally predicted, and thus depends on another frame, and the decoding is to be performed in constrained intra mode.

In a preferred embodiment, the blocks CUₖ₋ₘ and CUₖ₊ₚ, are the closest blocks to CUₖ in a respective direction within the range [CU₁-CUₖ₋₁, CUₖ₊₁-CU_{N}] of blocks (cf. 1D vector illustrated in figures and 9), which are available for Intra prediction. However, alternatively or in addition, pixel values could be estimated based on pixel values of one or more other blocks, which are available for Intra prediction, located beyond or further away than, as seen from the block CUₖ, the closest blocks to CUₖ in a respective direction within the range [CU₁-CUₖ₋₁, CUₖ₊₁-CU_{N}] of blocks.

Using one or both of the closest blocks to CUₖ in a respective direction, which are available for Intra prediction, within the range [CU₁-CUₖ₋₁, CUₖ₊₁-CU_{N}] of blocks for estimation of new pixel values (available for Intra prediction) would yield a good approximation of “true” pixel values, under the assumption that the correlation between the estimated pixel values and the “true” pixel values decreases with spatial distance.

In FIG. 13b, the action of determining whether one or more neighboring blocks are unavailable for intra prediction is illustrated as action 1302. If it is determined in action 1302 that one or more neighboring blocks are unavailable for Intra prediction, pixel values for positions covered by said unavailable block(s) are estimated in action 1306, as previously described. If all neighboring blocks are determined to be available for Intra prediction, the current block is decoded using pixel values of the neighboring blocks, in an action 1304.

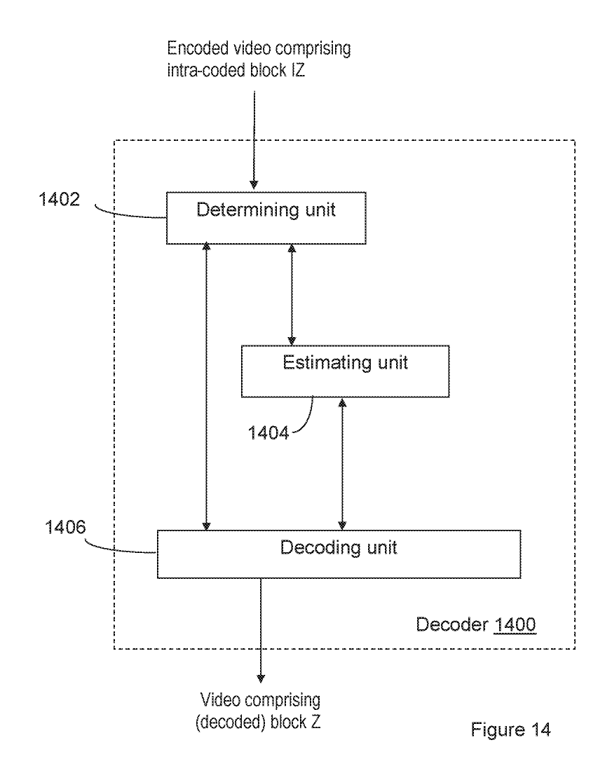

A generalized decoder for decoding an Intra coded block, IZ, will be described below with reference to FIG. 14. As described above, the intra coded block IZ is assumed to have a number N of neighboring blocks, CU₁-CU_{N}. The block IZ and the neighboring blocks are assumed to be provided to the decoder as input, e.g. as a part of a video stream. The decoder in FIG. 14 is illustrated as comprising a determining unit 1402, an estimation unit 1404, and a decoding unit 1406. These units or modules may represent processing circuitry, which is configured to perform the actions described above in conjunction with FIGS. 13a and 13b. The determining unit 1402 is adapted to determine whether a block CUₖ of the number of neighboring blocks is unavailable for intra prediction. The estimating unit 1404 is adapted to, when it is determined (by the determining unit 1402) that a block CUₖ is unavailable for intra prediction, estimate pixel values for spatial positions covered by CUₖ (cf. position 1-4 in FIG. 8). The pixel values are estimated based on at least one pixel value of at least one of blocks CUₖ₋ₘ and CUₖ₊ₚ within the range [CU₁-CUₖ₋₁, CUₖ₊₁-CU_{N}] of blocks, as described above. The decoding unit 1406 is adapted to decode block IZ using the estimated pixel values. Thus, by the decoding of the block IZ, a block Z of pixels is generated, which block may be provided e.g. to a video display or other visualization device. As above: k, m and p are integers, and 1≦k≦N; 1≦m<k; and 1≦p≦N-k; and N is a positive integer.

The decoder or units described above may be implemented by e.g. one or more of: a processor or a micro processor and adequate software stored in a memory, a Programmable Logic Device (PLD), Field-Programmable Gate Array (FPGA), Application-Specific Integrated Circuit (ASIC) or other electronic component(s) configured to perform the actions mentioned above.

The decoder may be implemented in different embodiments corresponding to the embodiments of the procedure described above in conjunction with FIGS. 13a and 13b.

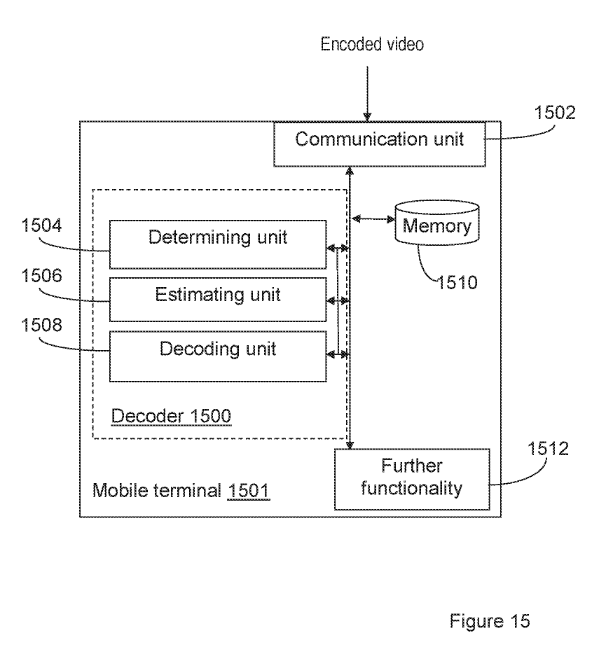

FIG. 15 illustrates a mobile terminal 1501, such as e.g, a User Equipment (UE) in a cellular communication network or a tablet, comprising a decoder 1500 as the one described above. The exemplifying mobile terminal in FIG. 15 further comprises a communication unit 1502 for communicating with other entities, such as e.g. radio base stations. The mobile terminal 1501 may further comprise one or more memories, e.g. for storing of coded video, and further functionality 1512, such as a camera for capturing video and a display/screen for displaying video. The encoded video provided to the decoder may be retrieved e.g. from another entity via the communication unit 1502, or from a memory 1510 within the mobile terminal. The mobile terminal may further comprise an encoder as the one described above.

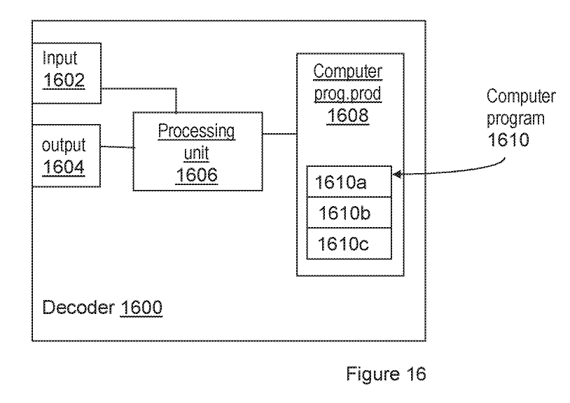

FIG. 16 schematically shows a possible embodiment of a decoder 1600, which also can be an alternative way of disclosing an embodiment of the decoder illustrated in FIG. 14. Comprised in the decoder 1600 are here a processing unit 1606, e.g. with a DSP (Digital Signal Processor). The processing unit 1606 may be a single unit or a plurality of units to perform different actions of procedures described herein. The decoder 1600 may also comprise an input unit 1602 for receiving signals from other entities, and an output unit 1604 for providing signal(s) to other entities. The input unit 1602 and the output unit 1604 may be arranged as an integrated entity.

Furthermore, the decoder 1600 comprises at least one computer program product 1608 in the form of a non-volatile memory, e.g. an EEPROM (Electrically Erasable Programmable Read-Only Memory), a flash memory and a hard drive. The computer program product 1608 comprises a computer program 1610, which comprises code means, which when executed in the processing unit 1606 in the decoder 1600 causes the decoder to perform the actions e.g. of the procedure described earlier in conjunction with FIGS. 13a and 13b.

The computer program 1610 may be configured as a computer program code structured in computer program modules. Hence, in an exemplifying embodiment, the code means in the computer program 1610 of the decoder 1600 comprises a determining module 1610a for determining determine whether a block CUₖ of the number of neighboring blocks is unavailable for intra prediction. The computer program further comprises an estimation module 1610b for estimating pixel values for spatial positions covered by CUₖ when needed.

The computer program 1610 further comprises a decoding module 1610c for decoding block IZ using the estimated pixel values. The computer program 1610 could further comprise other modules for providing other desired functionality.

The modules 1610a-c could essentially perform the actions of the flow illustrated in FIG. 13b, to emulate the decoder illustrated in FIGS. 14 and 15.

Although the code means in the embodiment disclosed above in conjunction with FIG. 16 are implemented as computer program modules which when executed in the processing unit causes the decoder to perfonn the actions described above in the conjunction with figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as ASICs (Application Specific integrated Circuit). The processor may also comprise board memory for caching purposes. The computer program may be carried by a computer program product connected to the processor. The computer program product may comprise a computer readable medium on which the computer program is stored. For example, the computer program product may be a flash memory, a RAM (Random-access memory) ROM (Read-Only Memory) or an EEPROM, and the computer program modules described above could in alternative embodiments be distributed on different computer program products in the form of memories within the network node.

In a similar manner, an exemplifying embodiment comprising computer program modules could be described for the encoder illustrated in FIG. 11.

It is to be understood that the choice of interacting units or modules, as well as the naming of the units are only for exemplifying purpose, and nodes suitable to execute any of the methods described above may be configured in a plurality of alternative ways in order to be able to execute the suggested process actions.

It should also be noted that the units or modules described in this disclosure are to be regarded as logical entities and not with necessity as separate physical entities.

What is claimed is:

1. A method for decoding an intra coded block IZ having a number N of neighboring blocks CU₁-CU_{N}, the method comprising:
when at least two blocks CUₖ and CUⱼ of the neighboring blocks are unavailable for intra prediction:
estimating pixel values for spatial positions covered by CUₖ by extrapolating from the closest neighboring block CUₖ₋₁ that is available for intra prediction;
estimating pixel values for spatial positions covered by CUⱼ by extrapolating from the closest neighboring block that is available for intra prediction; and
decoding block IZ using the estimated pixel values for prediction, thus generating a block Z of pixels,
where k and j are integers, and 2≦k≦N; k+2≦j<N; and N is a positive integer, and
wherein values of N≦5 and N>5 are supported.

2. The method according to claim 1, wherein the block CUₖ or CUⱼ belongs to a different slice than the block IZ.

3. The method according to claim 1, wherein the block CUₖ or CUⱼ is unavailable due to at least one of:
CUₖ or CUⱼ is temporally predicted, and the decoding is to be performed in constrained intra mode; and
CUₖ or CUⱼ is not yet decoded.

4. A decoder for decoding an intra coded block IZ having a number N of neighboring blocks CU₁-CU_{N}, the decoder comprising a processing circuit configured to:
determine that at least two blocks CUₖ and CUⱼ of the of neighboring blocks are unavailable for in prediction;
estimate pixel values for spatial positions covered by CUₖ by extrapolating from the closest neighboring block CUₖ₋₁ that is available for intra prediction;
estimate pixel values for spatial positions covered by CUⱼ by extrapolating from the closest neighboring block CUⱼ₋₁ that is available for intra prediction; and
decode block IZ, using the estimated pixel values for prediction, thus generating a block Z of pixels,
where k and j are integers, and 2≦k≦N; k+2≦j<N; and N is a positive integer, and wherein the decoder supports values of N≦5 and N>5.

5. The decoder according to claim 4, wherein the block CUₖ or CUⱼ belongs to a different slice than the block IZ.

6. The decoder according to claim 4, wherein the block CUₖ or CUⱼ is unavailable due to at least one of:
CUₖ or CU ⱼ is temporally predicted, and the decoding is to be performed in constrained intra mode; and
CUₖ or CUⱼ is not yet decoded.

7. The decoder according to claim 4, wherein the decoder is comprised in a mobile terminal.

8. A method for encoding a block Z of pixels, the block Z having a number N of neighboring blocks CUₖ-CU_{N} of pixels, and the method comprising:
when at least two blocks CUₖ and CUⱼ of the neighboring blocks are unavailable for intra prediction:
estimating pixel values for spatial positions covered by CUₖ by extrapolating from the closest neighboring block CUₖ₋₁ that is available for intra prediction;
extrapolating pixel values for spatial positions covered by CUⱼ by extrapolating from the closest neighboring block CUⱼ₋₁ that is available for intra prediction; and
encoding the block Z, using the estimated pixel values for intra prediction, thus generating an intra-coded block IZ,
where k and j are integers, and 2≦k≦N; k+2≦j<N; and N is a positive integer, and
wherein values of N≦5 and N>5 are supported.

9. The method according to claim 8, wherein the block CUₖ or CUⱼ belongs to a different slice than the block Z.

10. The method according to claim 8, wherein the block CUₖ or CUⱼ is unavailable due to at least one of:
CUₖ or CUⱼ is temporally predicted, and the encoding is to be performed in constrained intra mode; and
CUₖ or CUⱼ is not yet encoded.

11. An encoder for encoding of a block Z of pixels, the block Z having a number N of neighboring blocks CU₁-CU_{N}, the encoder comprising a processing circuit configured to:
determine that at least two blocks CUₖ and CUⱼ of the neighboring blocks are unavailable for intra prediction;
estimate pixel values for spatial positions covered by CUₖ, by extrapolating from the closest neighboring block CUₖ₋₁ that is available for intra prediction;
estimate pixel values for spatial positions covered by CUⱼ by extrapolating from the closest neighboring block CUⱼ₋₁ that is available for intra prediction; and
encode the block Z, using the estimated pixel values for intra prediction, thus generating an intra-coded block IZ,
where k and j are integers, and 2≦k≦N; k+2≦j<N; and N is a positive integer, and
wherein the encoder supports values of N≦5 and N>5.

12. The encoder according to claim 11, wherein the block CUₖ or CUⱼ belongs to a different slice than the block Z.

13. The encoder according to claim 11, wherein the block CUₖ or CUⱼ is unavailable due to at least one of:
CUₖ CUⱼ is temporally predicted, and the encoding is to be performed in constrained intra mode; and
CUₖ or CUⱼ is not yet encoded.

14. The encoder of claim 11, wherein the encoder is comprised in a mobile terminal.
